(19) United States
(12) Patent Application Publication
(10) Pub. No.: US 2008/0008433 A1
(43) Pub. Date: Jan. 10, 2008

(54) Extrusion

(76) Inventor: Jeremy Joseph Parker, Ipswich (AU)

Correspondence Address: Martin P. Hoffman;HOFFMAN, WASSON & GITLER, P.C., Suite 522, 2461 South Clark Street, Arlington, VA, 22202, US

(21) Appl. No.: 11/822,305

(22) Filed: Jul. 5, 2007

(30) Foreign Application Priority Data
Jul. 5, 2006 (AU) 2006903623

(51) Int. Cl. G02B 6/036

(52) U.S. Cl. 385/128

(57) ABSTRACT

An extrusion for fixing cladding boards to a support structure, said extrusion comprising an external face, a lower board engaging portion, an upper board engaging portion and a projection extending beyond one of the board engaging portions and adapted to allow the extrusion to be attached to said support structure.

The present invention relates to extrusions, and in particular extrusions of the type used for attaching timber cladding to the wall of a structure.

### BACKGROUND TO THE INVENTION

Many structures, such as houses or commercial buildings, are fitted with cladding in the form of timber boards. This cladding may be used on the external wall of a building, or on an internal wall in order to create an attractive decorative effect.

Timber or replica timber boards have been used in housing for external and internal walls for hundreds of years. The building industry is familiar with the construction of such walls and the public at large is very used to seeing constructions having horizontal boards as cladding. Weather boards have been used where the boards overlap by having the lower edge of the board extend over the upper edge of the board above to provide a weather proof cladding. Other methods of construction include tongue and groove constructions where a tongue extends from one edge of a board and engages a groove in the opposed edge of an adjacent board. These constructions provide walls of an homogenous appearance.

Architects are always striving to provide unique and different appearances in their projects. There have been some attempts to produce a cladding that has a unique appearance and boards have been interlinked with metallic strips to provide a striped appearance of timber and non-timber. In the past, aluminum extrusions have been used as the non-timber product. In shopfitting, for instance, a hollow aluminum extrusion is used such that hooks and other accessories may be clipped onto it. However, this type of extrusion leaves an unattractive gap in the wall. Additionally, this type of extrusion cannot be used to construct exterior walls as the gap left between boards traps moisture which would in turn degrade the timber.

We have now found an extrusion that may at least partially ameliorate the above-mentioned disadvantages, or which may provide a useful or commercial choice by providing an extrusion adapted to engage with the surrounding timber cladding in such a way as to provide a waterproof seal, allowing the cladding to be applied to both interior and exterior walls.

### SUMMARY OF THE INVENTION

In one broad form, the present invention resides in an extrusion for fixing cladding boards to a support structure, said extrusion comprising an external face, a lower board engaging portion, an upper board engaging portion and a projection extending beyond one of the board engaging portions and adapted to allow the extrusion to be attached to said support structure.

The lower and upper board engaging portions may be independently selected from male and female portions adapted to engage respective correspondence female and male portions on the edges of respective cladding boards.

For outdoor application, it is preferred that the lower board engaging portion is a female portion. This construction assists in weather proofing the cladding.

In a first preferred form of the present invention, there is provided an extrusion for fixing cladding boards to a support structure, said extrusion comprising an external face, a female lower board engaging portion for receiving a protruding tongue from a lower cladding board, an upper board engaging portion in the form of a tongue adapted to engage with a corresponding recess in an upper cladding board, and an upper projection extending beyond said upper board engaging portion and adapted to allow the extrusion to be attached to said support structure.

Advantageously, the present invention produces a waterproof seal between the extrusion and the cladding board. No moisture may be trapped behind the extrusion which means that the timber cladding will have an extended life. In addition, by providing a waterproof seal between the extrusion and the timber board, the cladding can be applied to the exterior surface of a wall as exposure to the elements will not have an adverse effect on the life of the cladding.

The extrusion of the present invention has an external face which, in use, is visible to an observer between the boards above and below the extrusion. If desired, this external face could bear some kind of decorative pattern, which, unlike existing extrusions, would further enhance the attractive appearance of the wall.

The external face of the extrusion is preferably set out from the projection in order to fix the external face of the extrusion the desired distance from the support structure and preferably in line or set slightly back from the external faces of the timber boards. The position of the external face is preferably set by a brace that extends from the rear of the extrusion to the external face.

The external face of the extrusion may preferably provide part of the engagement between the extrusion and adjacent boards. In one embodiment the external face may also be the upper board engaging portion in that the external face is adapted to extend into the corresponding recess in the upper cladding board.

In another embodiment the upper board engaging portion may be set back from the external face to permit the external face to be flush or nearly flush with the external face of the cladding.

The lower part of the external face of the extrusion may also provide a wall of the female lower board engaging portion of the extrusion, with a brace extending from the rear of the extrusion providing an upper wall of the female lower board engaging portion and the rear wall of the female lower board engaging portion being provided by a rear wall of the extrusion. In this embodiment the extrusion may be generally H-shaped, with the rear wall extending upwardly above the height of the front wall to permit the attachment of the extrusion to the support structure.

The projection may preferably be upwardly disposed to permit upward construction of the fixation of cladding boards and be provided with a lip adapted to support the upper cladding and reduce the stresses applied to the cladding from the cladding bearing on the first upper projection. The cladding is preferably provided with land for resting on a lip on the second upper projection.

The extrusion of the present invention also provides the construction with added stability due to the fact that the extrusion itself is adapted to be attached directly to the wall or building frame behind the cladding.

It is within the scope of the present invention that the extrusion be made of plastics material or other extrudable material. Preferably, the extrusion of the present invention is made of aluminum. The cladding boards may also be of any suitable material including wood, plastic or metal.

In a second aspect, the present invention resides in a method for cladding a support structure comprising the steps of engaging the female lower board engaging portion of an extrusion as described above in the first preferred form to a lower cladding board, affixing the upper projection of the extrusions to the support structure, engaging an upper cladding board to the tongue of the extrusion and repeating the steps to clad the support structure.

In a third aspect, the present invention resides in a wall constructed using the method of the second form of the invention.

The method of cladding of the present invention may be applied to the cladding of internal and external walls in addition to the cladding of other structures including garage doors and other structures.

### BRIEF DESCRIPTION OF THE DRAWINGS

In order that the various aspects of the invention may be more fully understood and put into practical effect, a number of preferred embodiments will be described with reference to the accompanying drawings, in which:

FIG. 1 shows a side view of the extrusion of the present invention when in use.

FIG. 2 shows a side view of an extrusion, representing an alternative embodiment of the invention, when in use.

### DETAILED DESCRIPTION OF THE DRAWINGS

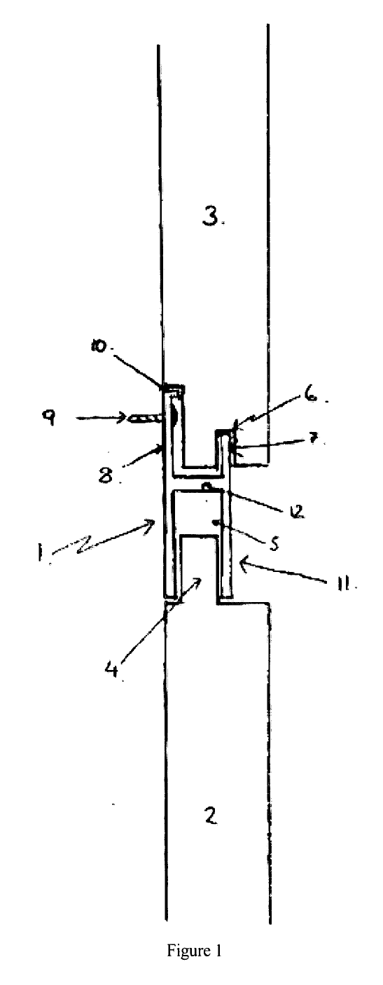

In FIG. 1, the extrusion (1) of the present invention is connected to a lower cladding board (2) and an upper cladding board (3). The lower cladding board (2) is held in place in the extrusion by inserting a protruding tongue (4) on the lower cladding board into a female portion (5) of the extrusion. The upper cladding board (3) engages with the extrusion through the engagement of a recess (6) in the board with an upper tongue (7) of the extrusion.

The extrusion also comprises an upper projection (8) which is designed to allow the extrusion to be fixedly attached to a wall or the framework of a building using anchoring means (9). While the embodiment of the invention illustrated uses a screw for the anchoring means, any other suitable means, such as a nail or rivet, may also be used.

In the embodiment of the invention illustrated in FIG. 1, the upper projection (9) has a lip (10) to provide additional support for the upper cladding board (3) which rests on the lip when in place.

The extrusion of the present invention has as external face (11) which is visible between the upper and lower cladding boards. In the embodiment of the invention illustrated in FIG. 1, the upper tongue (7) forms a part of the external face (11). The external face is connected to the rear of the extrusion by a brace (12).

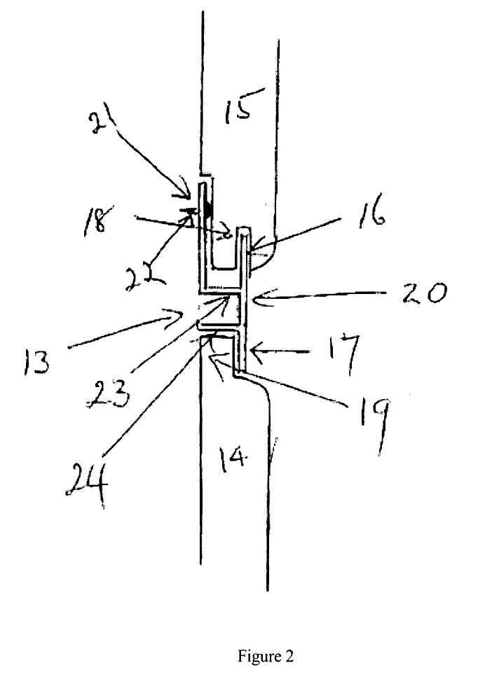

In FIG. 2, an alternative embodiment of the invention is shown in which an extrusion (13) engages with a lower cladding board (14) and an upper cladding board (15). The extrusion is provided with upper and lower board engaging portions (16 and 17, respectively) which in this embodiment are both male portions and correspond to female portions on the upper and lower cladding boards (18 and 19, respectively).

The upper and lower board engaging portions (16 and 17) form a part of the external face (20) which is visible between the upper and lower cladding boards.

The extrusion illustrated in FIG. 2 also comprises a projection (21) which extends beyond the upper board engaging portion (16) and is adapted to allow the extrusion to be fixedly attached to a wall or the framework of a building using suitable anchoring means (22).

The embodiment of the invention illustrated in FIG. 2 also comprises a brace (23) which extends between the rear of the extrusion and the external face (20). Optionally, a lip (24) extends from the external face and provides added stability to the construction by enabling the lower cladding board (14) to rest on the lip when in use. If, optionally, the lip (24) is absent from the extrusion, the lower cladding board (14) will rest on the brace (23).

Persons skilled in the art will appreciate that the invention described above may be subject to improvements and modifications that will be apparent without departing from the spirit and scope of the invention described herein.

I claim:

1. An extrusion for fixing cladding boards to a support structure, said extrusion comprising an external face, a lower board engaging portion, an upper board engaging portion and a projection extending beyond one of the board engaging portions and adapted to allow the extrusion to be attached to said support structure.

2. An extrusion according to claim 1 wherein a brace extends between the rear of the extrusion and the external face.

3. An extrusion according to claim 1 wherein said projection forms a portion of the external face.

4. An extrusion according to claim 1 wherein the external face may be provided with a decorative finish.

5. An extrusion according to claim 1 wherein the extrusion is made of aluminum.

6. An extrusion for fixing cladding boards to a support structure, said extrusion comprising an external face, a female lower board engaging portion for receiving a protruding tongue from a lower cladding board, an upper board engaging portion in the form of a tongue adapted to engage with a corresponding recess in an upper cladding board, and upper projection means extending beyond said upper board engaging portion and adapted to allow the extrusion to be attached to said support structure.

7. An extrusion according to claim 2 wherein a brace extends between the rear of said extrusion and the external face.

8. An extrusion according to claim 6 wherein said upper projection means comprises a first upper projection that forms a portion of the external face.

9. An extrusion according to claim 8 wherein said upper projection means comprises a second upper projection that forms a portion of the rear of the extrusion.

10. An extrusion according to claim 9 wherein said second upper projection further comprises a lip to provide additional support for an upper cladding board.

11. A method for cladding a support structure comprising the steps of engaging the female lower board engaging portion of an extrusion as described above in the first preferred form to a lower cladding board, affixing the upper projection of the extrusions to the support structure, engaging an upper cladding board to the tongue of the extrusion and repeating the steps to clad the support structure.

12. A method according to claim 11 wherein the suitable anchoring means may include a screw, nail or rivet.

13. A wall constructed using the method of claim 10.
